(19) United States
(12) Patent Application Publication
(10) Pub. No.: US 2008/0201230 A1
(43) Pub. Date: Aug. 21, 2008

(54) Internet-based method of and system for equity ownership optimization within a financial and retail marketplace

(76) Inventor: Joshep H. Hardison, Darven, CT (US)

Correspondence Address: Joseph H. Hardison, III, 11 Near water lane, Darven, CT, 06820, US

(21) Appl. No.: 12/070,409

(22) Filed: Feb. 19, 2008

Related U.S. Application Data
(60) Provisional application No. 60/901,962, filed on Feb. 16, 2007.

(51) Int. Cl. G06Q 30/00

(52) U.S. Cl. 705/14

(57) ABSTRACT

A system and method(s) for “loading” coupons, discounts, rebates, offers and other incentives onto purchase/payment vehicles by a consumer, who may or may no be an equity stake holder in a company with which various “loaded” offers are associated. Furthermore, the system and method(s) of the present invention allow a consumer to design his/her purchase/payment vehicle by pre-defining various desired purchase/payment vehicle attributes for inclusion in the consumer's purchase/payment vehicle. The consumer-designed purchase/payment vehicles will allow a consumer to discern and “load” various offers from companies in which the consumer holds an equity stakeholder interest, thereby allowing the consumer to purchase goods and services from those companies helping those companies' fortunes and, thus potentially increasing the value of the consumer's equity stake holdings.

The present application continues to build on prior application No. 60/901,962, from which priority has been claimed herein with an original filing date of Feb. 16, 2007.

### BACKGROUND OF INVENTION

1. Field of Invention

The present invention relates to an Internet-based method of, and system for, enabling both owners and non-owners (consumers) of equity interests in companies the freedom to exercise the rights and receive full benefits of various offers, discounts and other incentives from participating companies by “loading” such offers, discounts and other incentives onto a purchase or payment product, which the consumer can custom-design based on various pre-specified criteria.

2. Brief Description of the State of Knowledge in the Art

FIG. 1 is a schematic representation of the “Conventional Equity Ownership Benefits Derived by Equity Owners and Equity-Issuing Companies”, whereby equity ownership benefits represent the primary benefits derived by both equity owners and equity-issuing companies when a company issues/sells an ownership interest; both parties derive certain benefits through the equity issuance process.

FIG. 2 is a schematic representation of “Conventional Credit & Debit Card Usage Rewards” illustrating the limited, traditional types of benefits users derive when using a bank-issued credit or debit card, where the benefits are confined to some sort of pre-defined, limited cash back, airline miles, points or other reward(s) based on card usage.

Users of credit and debit cards are able to compare different card offerings from financial institutions when choosing a card (or cards) to use in everyday commerce. The problem with selecting a traditional card offered by a bank or financial institution is that the rewards and benefits offered by a specific card (credit or debit) are limited to a pre-defined set of rewards and, in many cases, one reward precludes another; a user has to choose between cash back and airline miles, two different airlines, etc.

Furthermore, by receiving a limited set of rewards for card usage, a card user may not act in his/her best interest when using a card with limited, pre-specified rewards. An example of this would be where a card user accrues airline miles on one airline via card usage but owns equity (stock) in a different airline. In this example, the card user's behavior is actually detrimental to his/her underlying investment interest(s).

Conventional credit aid debit cards do little to encourage customer/investor loyalty beyond the limited rewards offered by a specified credit or debit card. There is little incentive for a card user to favor a broad array of products and services from different companies when the reward(s) on a card only favor(s) one company's products or services. Yet the card user may have a variety of products and services that he/she uses a lot and, to which, he/she would be more loyal if his/her card's rewards for usage were broader in nature and based on either products and services a cardholder favors or, in which, a cardholder has an ownership stake.

Finally, consumers that own equity interests in companies have little incentive to use those companies' products and/or services other than to try, on an individual basis, to help those companies' business prospects. At the same time, many companies issue various rebates, rewards, discounts, coupons and other offers/incentives to the general public as inducements to use their products and/or services. Most of these inducements are offered for free, thus giving no advantage to a company's actual owners over non-owners.

In U.S. Pat. No. 7,318,041, Walker, et al. disclose an incentive reward system, wherein there is “a frequent shopper reward system capable of tracking performance data of a plurality of members or account holders linked to a single frequent shopper account.” This relates to multiple users linked to a single frequent shopper account.

U.S. Pat. No. 7,240,843 (Paul, et al) disclose a “Universal Club Card and Real-Time Coupon Validation”, in which a “Universal Club Card” that combines coupon scanning, coupon redemption, coupon distribution, loyalty cards, club cards, gift cards, frequent shopper programs, store credits and many other retail store promotions into one efficient and convenient portable scanning device.

In U.S. Pat. No. 7,233,913, Scroggie, et al disclose a system and method for the distribution of incentives and other shopping aids via a computer network, in which a consumer receives various coupons, etc, at his computer terminal and prints them for redemption at local merchants. Such printed coupons may also contain data identifying the consumer.

U.S. Pat. No. 7,013,286 (Aggarwal, et al) discloses a system wherein a “coupon mint” generates unforgeable, blank digital coupons, wherein the promoter of the offer(s) then fills in the terms of the coupon agreement.

U.S. Pat. No. 6,932,270 (Fajkowski) discloses a method and apparatus for coupon management and redemption, which, in essence, is a portable coupon card that contains, among other things, “a bar code scanner, a memory means, a display screen, and a communications port, all controlled by a microprocessor and operational keys.”

In U.S. Pat. No. 6,237,145, Narasimhan, et al disclose a “System for Accessing Promotion Information and for Generating Redeemable Coupons” The user electronically clips the coupon offer from a presented record, and the electronic clipped coupon is stored. At the merchant, the electronic clipped coupon is accessed and reviewed, and a paper coupon corresponding to the electronic clipped coupon is selectively generated for redemption by the merchant.

Various methods and systems have been proposed for electronic coupon generation, management and redemption at a single e-commerce site. In U.S. Pat. No. 5,894,520, Nielsen discloses a “Method and System for Regulating Discounts on Merchandise Distributed Through Networked Computer Systems”, wherein a method and a system for regulating discounts on merchandise, at a vendor location, through networked computer systems. The system includes a user computer and a vendor computer connected via a network. When a user purchases merchandise, the vendor issues an encrypted discount coupon for repurchase of the merchandise. When the user desires to repurchase the merchandise, the user sends a request to the vendor along with the encrypted coupon. The vendor verifies the coupon and gives the discount.

An earlier paper by the authors (M. Kumar, A. Rangachari, A. Jhingran, and R. Mohan, “Sales Promotions on the Internet”, Third USENIX Workshop on Electronic Commerce, Boston, 31 Aug. 3 Sep. 1998, pp. 167 176) describes a form of sales promotion for online merchants called c-coupons. A buyer need not print c-coupons as they can be captured electronically in an electronic coupon-wallet, and later redeemed electronically on the same on-line store. They solve the issue of targeted, limited online distribution and redemption of electronic coupons at a single online store, but it is not clear how they can handle coupons issued by a manufacturer which may get redeemed at any online store.

Several centralized service provider-based systems have also been proposed for giving merchandise discounts. These systems do not issue any coupons to the customer, but just offer various discounts when the customer visits the retailer store for shopping. In U.S. Pat. No. 5,185,695, Pruchnicki discloses a “Method and System for Handling Discount Coupons by Using Centrally Stored Manufacturer Coupons in Place of Paper Coupons”, wherein a method and system for handling discount coupons by using centrally stored manufacturer coupons in place of paper coupons is described, to save costs of printing and distributing and clearing paper coupons. The method and apparatus includes a central processor that receives information of product type, validation period and coupon value from manufacturers and produces a central coupon list of available coupon discounts. The central list is transmitted to retailers, who produce a local coupon list based on the central list containing only those manufacturers and product types which the retailer holds for sale. The customer buys a product and as the product is moved through the checkout station, coupon discount, if any applicable, is deducted from the retail price. The central processor directly bills the manufacturer or transfers funds.

U.S. Pat. No. 5,924,080 (Johnson) discloses a “Computerized Discount Redemption System”, wherein a similar method of giving merchandise discounts by using a membership system comprising of a centralized system provider, multiple manufacturers, multiple merchants and multiple customers. But none of these systems are doing any targeted discounts; they are just giving discounts on the customer purchases without issuing any coupons to the customer at all, hence they do not describe any coupon distribution, redemption or verification mechanisms.

Several e-commerce sites provide targeted offers that the consumer has the opportunity to select. After selecting their offers online, consumers receive them either by mail or redeem them at supermarkets with modem point-of-sale systems by swiping their frequent shopper card, the offers being automatically deducted at the point of sale. This system does targeted coupon distribution, but coupons can be redeemed only at physical retail shop. These sites/systems also require the consumers to have a frequent shopper membership and that central servers maintain all coupon and consumer selection details.

In U.S. Pat. No. 5,909,673, Gregory discloses a “Method and System for Creating Site Specific Coupons at a Plurality of Remote Locations Which are Controlled by a Central Office”, wherein a central server connected to multiple remote sites to allow retailers to be able to customize discounts and coupon details according to a particular store location. A general coupon template is loaded onto the central server alone, with site specific information to be printed on each coupon. A particular remote processing station at a remote site can call in to the central server and download the general coupon template and the site specific information for that particular site. The remote processing station then combines the template with the site specific information and prints the site specific coupon. These inventions describe mechanisms only for generation of targeted coupons, without any mention of online coupon redemption, verification and clearing.

In U.S. Pat. No. 5,855,007, Jovicic, et al discloses an electronic coupon issuing, redemption, verification and clearing system for an “Electronic Coupon Communication System”. This system comprises a first Internet node, an Internet coupon server and an Internet coupon notification center. The Internet coupon server generates a unique Internet coupon using a coupon generation process. The Internet coupon server accepts an on-line selection of one of the available unique Internet coupons from a user of the Internet node and transmits the coupon back to the user's printing device or e-mail storage. It then records the transaction in its coupon database and notifies the Internet Coupon Notification Center. The Internet Coupon Notification Center subsequently records the transaction. Furthermore, a coupon redemption center can electronically verify coupon validity and record coupon redemption by communicating with the Internet Coupon Notification Center. It handles online targeting, generation, redemption and verification of electronic coupons between a manufacturer and a plurality of retailers.

U.S. Pat. No. 5,502,636 (Clarke) discloses a “Personalized Coupon Generating and Processing System” that proposes a personalized coupon generating and processing system, which identifies a group of consumers that are likely to be responsive to coupons of predefined products and then distribute the coupons.

In U.S. Pat. No. 5,420,606, Begum et al, disclose an “Instant Electronic Coupon Verification System” that describes an instant electronic coupon verification system for a single physical store, in which the store provides shoppers with an electronic device to view, select and store from a plurality of coupons and later redeem the coupon on reaching a checkout counter, based on items purchased. This is also limited only to physical stores and does not talk about any targeted coupon distribution.

In U.S. Patent Application Number 20070250380, Mankoff discloses a “Delivery, Organization, and Redemption of Virtual Offers from the Internet, Interactive-TV, Wireless Devices and Other Electronic Means”, wherein methods and systems are disclosed for associating coupons with consumers' credit cards for redemption. While the goal is the same as the system and method(s) of the present invention, Mankoff's system requires “card matching agents”, wherein such card-matching agents would typically receive lists of consumers' identifiers, such as consumers' email addresses, and their credit card information.”

“In such approaches, an offer may be created by a merchant or other advertiser with the help of the list owner's agent or list manager, or the advertiser's agent, the list broker. The list manager creates the offer and enables it to be organized (in some embodiments) and redeemed paperlessly. For example, the list manager may take a 10% off offer for Retailer XYZ and then pre-organize the offer as “apparel,” “furniture,” “grocery,” “hardware,” merchandise,” or some other category (see FIG. 4). The list manager then gives the offer an identifier number. The list owner then delivers the limits of the offer to the matching agent. The list manager then appends the consumer's email address to the email itself. When the consumer “clicks” or accepts the enabled offer, it will cause an electronic acceptance message to be sent to the list manager, where the message comprises the email address that was associated with the offer identifier number when the offer was sent to the consumer. Upon receipt, the list manager transmits the email address and offer identifier to the matching agent, which then associates the email address with the consumer's associated credit card and adds the coupon identifier to the consumer's coupon database for later matching to a retail good or service transaction in which the consumer redeemed the promotional offer.”

This is a messy, complicated process for delivering coupons and other offers directly to a consumer for redemption via credit card usage.

In view of all of the aforementioned shortcomings, deficiencies and inefficiencies that exist in the local, national and global bank card products and marketplaces, there is still a great need in the art for an improved system and method(s) for solving these problems of limited rewards offered by banks' and financial institutions' credit, debit and other card products, while avoiding the shortcomings and drawbacks of the prior art apparatus and methodologies heretofore known.

### OBJECTS AND SUMMARY OF THE INVENTION

Accordingly, it is a primary object of the invention to provide a method of and system for solving the inefficiencies of prior art financial systems, while avoiding the shortcomings and drawbacks of the prior art apparatus and methodologies.

Another objective of the present invention is to provide an Internet-based method of and system that inherently recognizes that equity ownership in a company can be leveraged by obtaining additional discounts, rebates and coupons that can be loaded on credit, debit and other payment instruments, thereby enabling the maximization of economic value that such equity ownership can support within a society.

Another object of the present invention is to provide an Internet-based method and system, wherein equity holders can link electronically, or via the Internet, their equity portfolios including stock statements, mutual fund holdings, pension fund holdings and all other equity holdings/investments with their bank or financial institution in order to allow their bank or financial institution to load all offered discounts, rebates, coupons, etc, based on a customer's equity holdings, on a credit or debit card's magnetic strip or on any other payment vehicle so that the card/vehicle holder can utilize these discounts, rebates, coupons and other offers at the point-of-sale (POS).

Another object of the present invention is to provide an Internet-based method and system, wherein equity holders can link electronically, or via the Internet, their equity portfolios including stock statements, mutual fund holdings, pension fund holdings and all other equity holdings/investments with their bank or financial institution in order to allow their bank or financial institution to store all offered discounts, rebates, coupons, etc, based on a customer's equity holdings, in a database maintained by the bank or financial institution so that the card/vehicle holder can utilize these discounts, rebates, coupons and other offers at the point-of-sale (POS).

Another object of the present invention is to provide an Internet-based method and system, wherein equity holders can link electronically, or via the Internet, their equity portfolios including stock statements, mutual fund holdings, pension fund holdings and all other equity holdings/investments with their bank or financial institution in order to allow their bank or financial institution to load all offered discounts, rebates, coupons, etc, based on a customer's equity holdings, either on a credit or debit card's magnetic strip or, to store all offered discounts, rebates, coupons, etc, in a database maintained by the bank or financial institution, on any other payment vehicle so that the card/vehicle holder can receive credits for these discounts, rebates, coupons and other offers/incentives based on card/purchase vehicle usage.

Another object of the present invention is to provide an Internet-based system and method, wherein a user selects both free and purchasable discounts, coupons, rebates and other incentives to “load” onto a bankcard product or other purchase/payment vehicle, with such “loading” consisting of first registering the user's card(s), selecting various free and purchasable offers, and then storing those user-selected offers in a database, either within the system of the invention and/or at the user's bank (card issuer) for future recognition at a point of sale.

Another object of the present invention is to provide an Internet-based system and method, wherein all user-selected discounts, coupons rebates or other incentives are recognized at the point of sale when the point of sale terminal sends a bankcard authorization request to system user's bank, and all discounts, coupons, rebates or other incentives that are stored in the user's account within the bank's database are communicated back, electronically, to the point of sale terminal along with the bankcard authorization.

Another object of the present invention is to provide an Internet-based system and method, wherein all discounts, coupons, rebates or other incentives communicated back to the point of sale terminal electronically, can be delivered either through a direct reduction of the purchase price, a credit to the user's bankcard (credit card) account, or via direct deposit into a savings or other demand account maintained by the consumer.

Another object of the present invention is to provide credit, debit and other purchase/payment vehicle users an Internet-based method and system for designing and creating their own credit, debit and other purchase vehicles based on a bank's current card offerings (rebates, rewards, fee structures, interest rates, etc.), the user's equity holdings (and the equity holdings' rebates, rewards, discounts, coupons and other offers/incentives), and other discounts, rewards, rebates, coupons and other offers/incentives that a card (or other purchase/payment vehicle) user may receive for free or purchase from companies that offer such opportunities.

Another object of the present invention is to provide an Internet-based method and system for purchasing for inclusion, on a card product or other purchase/payment vehicle, non equity-owned related discounts, rewards, rebates, coupons or other offers/incentives that may be offered by companies providing goods and services.

Another object of the present invention is to provide an Internet-based method and system for enabling credit or debit card, or other purchase/payment vehicle, users, to select the various logos of all user selected companies offering discounts, rewards, rebates, coupons, and other offers and incentives as well as those logos of user non-equity owned companies that may be available for free or for purchase by user, for inclusion on the debit or credit card or on any other purchasing vehicle so that user is always aware of the various discounts, rebates, rewards, coupons and other offers/incentives available via the debit or credit card or other purchasing vehicle.

Another object of the present invention is to provide an Internet-based method and system for apprising a credit or debit cardholder (or holder of other purchase/payment vehicle) of all rebates, rewards, discounts, coupons and any other offers and incentives available to the cardholder as an owner of equities held in the user's portfolio, mutual funds held in the portfolio, or of equities in any other vehicle in which the cardholder may have an ownership interest.

Another object of the present invention is to provide an Internet-based method and system for apprising a credit or debit cardholder (or holder of other purchase/payment vehicle) of all rebates, rewards, discounts, coupons and any other offers and incentives made available to the cardholder for free.

Another object of the present invention is to provide an Internet-based method and system for apprising a credit or debit cardholder (or holder of other purchasing vehicle) of all additional rebates, rewards, discounts, coupons and any other offers and incentives available to the cardholder for purchase and inclusion on a card product or purchasing vehicle, irrespective of whether the cardholder is an owner of the company offering such rebates, rewards, discounts, coupons and any other offers and incentives.

Another object of the present invention is to provide an Internet-based system and method for allowing a user to purchase company-offered rebates, rewards, discounts, coupons and any other offers and incentives for inclusion on credit or debit cards (or other purchase/payment vehicles), whether the user has an equity interest in a particular company or not.

Another object of the present invention is to provide an Internet-based system and method for allowing a user to purchase additional company-offered rebates, rewards, discounts, coupons and any other offers and incentives for inclusion on credit or debit cards (or other purchasing vehicles) when the cardholder already has an equity ownership position in a company and such rebates, rewards, discounts, coupons and any other offers and incentives are offered in addition to those already provided to equity owners.

Another object of the present invention is to provide an Internet-based system and method for allowing a system user to update (purchase, remove, renew, etc.) various offered rebates, rewards, discounts, coupons and any other offers and incentives and to store user's selections for future updates and modifications.

Another object of the present invention is to provide an Internet-based system and method for allowing a user that has finalized all card (or purchasing vehicle) selections to transmit those selections to a bank or financial institution for inclusion in/on the user's credit or debit card or on any other purchase/payment vehicle selected with all user selections stored in a database at the bank or financial institution.

Another object of the present invention is to provide an Internet-based system and method for providing a user with various credit and debit card (and other purchase/payment vehicles) with information regarding companies' rebates, rewards, discounts, coupons and other offers/incentives based both on the user's equity holdings (direct and indirect) and on companies that both offer for free, and allow purchases of, rebates, rewards, discounts, coupons and other offers/incentives for non-equity holders.

Another object of the present invention is to provide an Internet-based system and method for providing a user with various credit and debit card (and other purchase/payment vehicles) with information regarding companies' rebates, rewards, discounts, coupons and other offers/incentives, based on the user's equity holdings (direct and indirect), that are available for purchase in addition to the various rebates, rewards, discounts, coupons and other offers/incentives already received as an equity holder (direct or indirect).

Another object of the present invention is to provide an Internet-based system and method for providing a user with bundled packages of rebates, rewards, discounts, coupons and other offers/incentives based on the user's frequently used products and services, with such rebates, rewards, discounts, coupons and other offers/incentives made available for purchase and/or inclusion in such packages.

Another object of the present invention is to provide an Internet-based system and method for allowing a user to change any and all credit card, debit card or other purchase/payment vehicle rebates, rewards, discounts, coupons and other offers/incentives by accessing the system of the present invention using pre-selected secure methods and clicking through the various menus provided; rebates, rewards, discounts, coupons and other offers/incentives may be both added and deleted from a card or purchasing vehicle via this process.

Another object of the present invention is to provide an Internet-based system and method for notifying potential and existing users, via the Internet, wireless communication, U.S. mail, phone or other means of communication, of new and/or improved offers/features to user's (or potential user's) credit or debit card or other purchasing vehicle.

Another object of the present invention is to provide an Internet-based system and method wherein participating companies may submit, save, and edit, their rebates, rewards, discounts, coupons and other offers/incentives for both equity holders (direct and indirect) and non-equity holders.

Another object of the present invention is to provide an Internet-based system and method for displaying all company-submitted offers for rebates, rewards, discounts, coupons and other offers/incentives for both equity holders (direct and indirect) and non-equity holders.

Another object of the present invention is to provide an Internet-based system and method for displaying all participating companies' free offers of coupons, rebates, discounts and other incentives that consumers may select for “loading” onto their card products.

Another object of the present invention is to provide an Internet-based system and method that allows consumers to register their current credit card(s), debit card(s) or other purchasing vehicles, with the system of the present invention in order to be able to “load” various free and purchased discounts, rebates, coupons and other incentives onto their existing bankcards or purchase/payment vehicles.

Another object of the present invention is to provide an Internet-based system and method for displaying all of a user's selected and earned rebates, rewards, discounts, coupons and other offers/incentives and card/vehicle balances.

Another object of the present invention is to provide an Internet-based system and method for notifying credit card, debit card or other purchase/payment vehicle holders of the expiration date(s) associated with any accrued rebates, rewards, discounts, coupons and other offers/incentives or of any offered rebates, rewards, discounts, coupons and other offers/incentives.

Another object of the present invention is to provide an Internet-based system and method for notifying users of any fees, charges, penalties, or other limitations or qualifications associated with all credit card, debit card and other purchasing vehicle(s) offered rebates, rewards, discounts, coupons and other offers/incentives.

Another object of the present invention is to provide an Internet-based system and method for allowing a prospective system user first to choose various offered rebates, rewards, discounts, coupons and other offers/incentives for inclusion in a credit card, debit card or other purchase/payment vehicle and, then, based on a user's pre-selections, the system of the present invention can recommend various banks and/or financial companies that can optimize the user's pre-selections.

Another object of the present invention is to provide an Internet-based system and method for facilitating transfers of credit card or other purchase/payment vehicle balances, along with all earned/purchased rebates, rewards, discounts, coupons and other offers/incentives, with such method notifying a system user of any potential fees, charges and penalties associated with such transfer(s) and, notifying a user of any possible rebates, rewards, discounts, coupons and other offers/incentives forfeitures based on a potential transfer.

Another object of the present invention is to provide an Internet-based system and method for automatically adding/deleting new rebates, rewards, discounts, coupons and other offers/incentives to a user's credit card, debit card or other purchase/payment vehicle either based upon changes in a user's equity holdings (direct and indirect) or on additional/retracted free offers from companies; changes will be forwarded to user's card or purchase/payment vehicle provider so that such provider can incorporate such additions (or deletions) and update the user's card reflecting these changes.

Another object of the present invention is to provide an Internet-based system and method for allowing a system user to purchase additional rebates, rewards, discounts, coupons and other offers/incentives, where available, from participating companies, whether user is and equity holder (direct or indirect) or not.

Another object of the present invention is to provide an Internet-based system and method for providing a card (or other purchase/payment vehicle) issuer with all relevant company and rebate, reward, discount, coupon and other offer/incentive information for encoding on user's system-designed card or purchase vehicle.

Another object of the present invention is to provide an Internet-based system and method for providing system users with secure Internet access codes for accessing all account information.

Another object of the present invention is to provide an Internet-based system and method for providing pre-packaged card/purchase vehicle products containing various rebates, rewards, discounts, coupons and other offers/incentives either formulated by the system of the present invention or tailored to a system user's pre-specified preferences and objectives.

Another object of the present invention is to provide an Internet-based system and method wherein participating companies that offer rebates, rewards, discounts, coupons and other offers/incentives to equity holders (direct or indirect) can pro rate the amount of offered rebates, rewards, discounts, coupons and other offers/incentives for inclusion in a card product or other purchasing vehicle based upon either the number of shares (units) owned, the total dollar amount of a company stock, the number of mutual find shares or the balance(s) in pension funds or other indirect ownership vehicles owned by the system user.

Another object of the present invention is to provide an Internet-based system and method wherein participating companies provide, via the system of the invention, all information relating to various offered rebates, rewards, discounts, coupons and other offers/incentives.

Another object of the present invention is to provide an Internet-based system and method wherein participating companies provide to system users one or more methods for purchasing stock directly from participating companies based on user use of the participating companies' products and/or services, with such verification provided by user supplying actual purchase/payment information to the system of the invention.

Another object of the present invention is to provide an Internet-based system and method wherein a system user can obtain all information about a company's offered rebates, rewards, discounts, coupons and other offers/incentives by either clicking on a company link on the system's Web site or by typing in either the company name or stock symbol.

Another object of the present invention is to provide an Internet-based system and method wherein a system user can type in a participating company's name or stock symbol and receive information on all of the various products and/or services offered by that company along with any special available rebates, rewards, discounts, coupons and other offers/incentives available on a product-by-product or service-by-service basis; this is available for both equity (direct and indirect) and non-equity holders.

Another object of the present invention is to provide an Internet-based system and method wherein a system user can type in a product's name and receive information about the company that owns the product (same, stock symbol, etc.) and see information about all available rebates, rewards, discounts, coupons and other offers/incentives, as well as information about other company products and services.

Another object of the present invention is to provide an Internet-based system and method wherein a participating company can reward a system user for an increased or high level of patronage by increasing the various rebates, rewards, discounts, coupons and other offers/incentives offered to a specific system user.

Another object of the present invention is to allow companies, owned or not owned by system users, from which a system user cannot benefit from a discount (oil drilling company as an example), to buy discounts from other participating companies to either distribute to their shareholders or to sell vis-à-vis the system of the invention.

Another object of the present invention is to provide an Internet-based system and method wherein a system user can select/input data based on what type of credit/debit card or payment vehicle (VISA, MasterCard, AmEx., other), card options (annual fee, interest rate, payment terms, rebates, discounts, etc.) and preferred financial institutions, and the system of the invention will recommend the bank(s) or financial institution(s) that most closely match the system user's specifications.

Another object of the present invention is to provide an Internet-based system and method wherein a participating company can make its rebates, rewards, discounts, coupons and other offers/incentives mutually exclusive with other companies competing in the same industry.

Another object of the present invention is to provide an system and method whereby companies can reward their shareholders (direct and indirect) with all available coupons (and other discounts and offers) that the company issues through print, flyers and other mediums by loading a company code (or individual product codes) onto a system user's credit card, debit card or other purchase/payment vehicle that automatically makes all coupon discounts related to the company's products directly at the point-of-sale, thus obviating the need for a consumer/system user to “clip” coupons for products from companies in which the system user has an equity ownership interest; loading of the company code(s) will be effected by a bank or financial institution.

Another object of the present invention is to provide an Internet-based method for companies to adjust the price of purchasable rebates, rewards, discounts, coupons and other offers/incentives on an individual basis based on a system user's purchases of the company's products to assure that the system user remains a customer and that the company optimizes both sales of its products and its purchasable rebates, rewards, discounts, coupons and other offers/incentives.

Another object of the present invention is to provide to a system user a method for keeping track of all realized rebates, rewards, discounts, coupons and other offers/incentives based both on the user's equity holdings and on purchased rebates, rewards, discounts, coupons and other offers/incentives where the user is not an equity holder.

Another object of the present invention is to provide unique, secure alphanumeric codes for each free and purchasable rebate, reward, discount, coupon and other offers/incentives provided by participating companies for storage in, and recognition by, the purchase/payment vehicle's database(s).

Another object of the present invention is to provide an Internet-based system and method whereby participating companies reimburse merchants for the merchant processing fees (bankcard interchange fees) incurred in processing credit, debit and other purchase/payment vehicle transactions; as part of a point-of-sale transaction, participating companies make restitution to the merchant commensurate with the transaction processing fee charged by the card company/association, thus allowing a merchant to promote participating companies' products and/or services at lower prices, and allowing the participating companies to increase sales.

Another object of the present invention is to provide an Internet-based system and method whereby private companies can also list available rebates, rewards, discounts, coupons and other offers/incentives for purchase and loading on a credit card, debit card or other purchasing vehicle.

These and other objects of the present invention will become more apparent from the descriptions and drawings contained herein, and are, by no means, confined or limited by other improvements or advantages that may be realized.

### BRIEF DESCRIPTION OF THE DRAWINGS

In order to more fully understand the Objects of the Invention, the following Detailed Description of the Illustrative Embodiments should read in conjunction with the appended figure drawings, wherein:

FIG. 1 is a schematic representation of the “Conventional Equity Ownership Benefits Derived by Equity Owners and Equity-Issuing Companies”, where equity ownership benefits represent the primary benefits derived by both equity owners and equity-issuing companies when a company issues/sells an ownership interest; both parties derive certain benefits through the equity issuance process;

FIG. 2 is a schematic representation of “Conventional Credit & Debit Card Usage Rewards” illustrating the limited, traditional types of benefits users derive when using a bank-issued credit or debit card, where the benefits are confined to some sort of pre-defined, limited cash back, airline miles, points or other reward(s) based on card usage;

FIG. 3 is a schematic representation of “Recognition of Equity Ownership Optimization Network (EOON) Rewards Incorporated in Conventional Credit and Debit Cards” where all currently offered credit and debit card and other purchase/payment vehicle rebates, rewards, discounts, coupons and other offers/incentives are shown under “Conventional Credit and Debit Card Usage Rewards” along with rebates, rewards, discounts, coupons and other offers/incentives made possible under the EOON of the system and methods of the present invention;

FIG. 4 is a high-level systems block diagram representation of the Internet-based EOON of the present invention, realized as an industrial strength, carrier class, globally-extensive packet-switched financial information management and communications network, designed as an object-oriented system on a Java-based object-oriented integrated development environment (IDE) such as, for example, WebObjects 5.2 IDE by Apple Computer Inc., Websphere IDE by IBM, or Weblogic IDE by BEA, or the Microsoft® Visual Studio 2005 .NET IDE;

FIGS. 5 and 5A are schematic representations of two alternative implementations of the enterprise-level EOON of the present invention using Apple's WebObjects® and its Java, Application Server as an exemplary systems development environment;

FIG. 6 is a schematic representation of the Internet-based Equity Ownership Optimization Network of the present invention, showing its various components interacting so as to enable a system user to obtain equity ownership-related rebates, rewards, discounts, coupons and other offers/incentives on goods and services based on the user's equity ownership positions (direct ownership and indirect ownership (mutual finds, etc.)), and free rebates, rewards, discounts, coupons and other offers/incentives on goods and services, fed to the EOON by participating companies, which can be “loaded” on a credit card, debit card or other purchasing vehicle by a bank or financial institution and stored in the bank's or financial institution's database(s) in order to allow the card or vehicle holder/user both to maximize equity ownership interests and to maximize free offers and incentives, thus maximizing the purchase/payment vehicle's utility;

FIG. 6A is a flow chart depicting the various steps carried out during the process of “loading” equity-based and free discounts, coupons, rebates, rewards and other offers and incentives on a purchase/payment vehicle of the present invention;

FIG. 7 is a schematic representation of an EOON system user's “Sample Customer Brokerage Statement”, which shows a user's/customer's individual equity ownership interests as well as a user's/customer's mutual fund holdings along with quantities, prices, percentage of total holdings, cost bases, income earned and the total value of both positions and the overall portfolio;

FIG. 8 is a schematic representation of the EOON's breakdown of a user's/customer's mutual fund holdings, showing individual equity position holdings of each mutual fund in the user's/customer's equity portfolio; such information is widely available via financial information providers;

FIGS. 9, 9A and 9B are a schematic representation of the “EOON” Equity Holdings Rebates, Rewards, Discounts, Coupons and other Offers/Incentives Menu” that shows the various discounts, coupons, rebates and other rewards, offers and incentives associated with equity ownership as well as the various discounts, coupons, rebates and other rewards, offers and incentives available to non-equity holders, as well as “Extra Discount Available”, which provides information on either extra discounts available for free or for purchase by equity holders or extra discounts available to non-equity holders; clicking on any of the information contained in the various rows/columns will provide further information about specific offers and incentives;

FIG. 10 is a schematic representation of the “EOON Participating Company's Data Collection Summary” that allows a user to click on an individual company's name and all relevant data regarding that company's participation in the EOON is displayed including, but not limited to: company name, stock symbol, discounts, coupons and rebates (and other offers/incentives) and, whether or not extra discounts are available to both equity holders and non-equity holders along with any other pertinent notes;

FIG. 11 is a schematic representation of the “EOON Menu of Companies Offering Free and Purchasable Rebates, Rewards, Discounts, Coupons and Other Offers and Incentives”, whereby participating companies' offers are listed along with the accompanying prices (if any) of purchasing these offers, the term of a purchased offer and any pertinent notes regarding the offer(s);

FIG. 12 is a schematic representation of the “EOON Participating Company Product List” that allows a system user to type in either a participating company's stock symbol or name and see the company's offers available to equity holders and non-equity holders as well as a complete list of that company's products;

FIG. 13 is a schematic representation of the “EOON User's Frequently Used Products Search Menu” that enables a system user to type in the name of a frequently used product (or service) and see the name of the company that offers it along with the company's stock symbol, benefits available to both equity holders and non-equity holders, and a complete list of the company's other products and/or services;

FIG. 14 is a schematic representation of the “EOON Participating Company Information Update Screen” that enables a company to join the EOON by listing its name/stock symbol and the various offers available to equity holders and non-equity holders and to save and edit that information at later dates; in the case of equity holders, it also allows a company to specify either a minimum amount of shares owned or a minimum holding period required to receive the equity holder's offers and whether or not the company offers a direct stock purchase plan;

FIG. 15 is a schematic representation of the “EOON Credit & Debit Card User Optimization Menu” that allows a system user to specify desired features in a credit or debit card (or other purchase/payment vehicle) including: what type of card (credit, debit, etc.), card brand (VISA, MasterCard, American Express, Discover, etc.), card features (annual fees, interest rates, payment terms, included rewards, rebates, discounts, etc., and even banks and financial institutions, with the system, based on the user's selections, recommending the bank and product that best satisfies the system user's desired card specifications;

FIG. 16 is a schematic representation of an “EOON System User's Credit/Debit Card” that shows the card's issuer logo (bank), association logo (VISA), sponsor and/or affinity organization logos, the card's number, expiry date, user's name, a hologram, various logos of the user's equity holdings from which the user has received rebates, rewards, discounts, coupons and other offers/incentives and/or logos of non-equity holdings from which the user has received or purchased rebates, rewards, discounts, coupons and other offers/incentives, along with a magnetic coding strip on which all data regarding credit limits, account balances, rebates, rewards, discounts, coupons and other offers/incentives, etc., is stored;

FIG. 17 is a schematic representation of the “EOON Bankcard/Purchase/Payment Vehicle “Loading” and Recognition Process” that is illustrative of the process by which a consumer receives a purchase/payment vehicle from an issuing bank, may or may not link his/her equity statement via the EOON, and selects various coupons, rebates, offers and other incentives through the EOON, which are supplied through the EOON by participating companies, for “loading” onto a purchase/payment vehicle with all “loaded” coupons, rebates, offers and other incentives selected being stored in a bank's or financial institution's database(s) for recognition when the consumer presents his/her purchase/payment vehicle at retailer point of sale and the retailer sends a payment authorization request to the purchase/payment vehicle issuing institution;

FIG. 17A is a flow chart depicting the various steps carried out in the EOON bankcard/purchase/payment vehicle “loading” and recognition process.

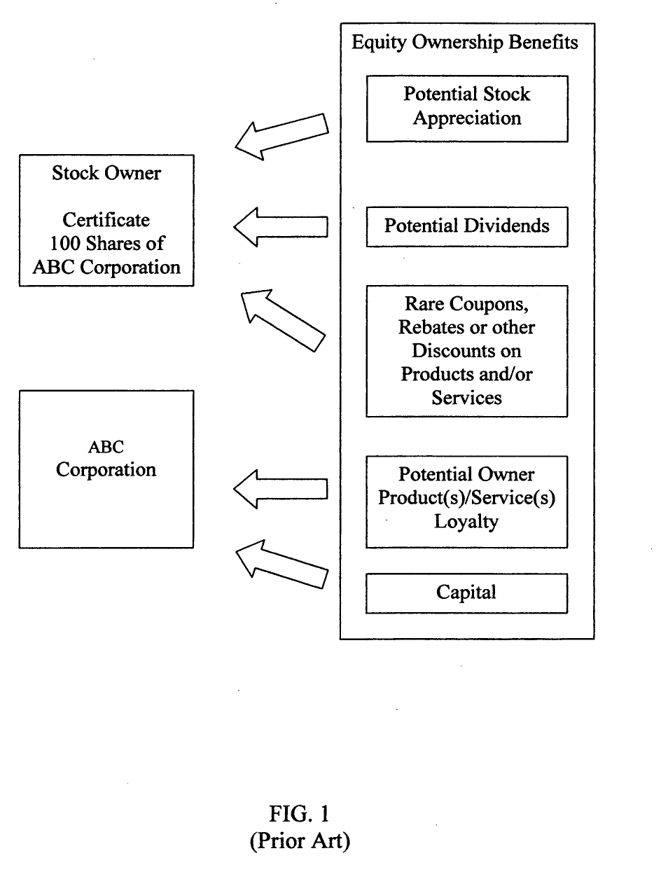

### DETAILED DESCRIPTION OF THE ILLUSTRATIVE EMBODIMENTS OF THE PRESENT INVENTION

Referring now to the figures in the accompanying Drawings, the illustrative embodiments of the present invention will now be described in great technical detail, wherein like parts are indicated by like reference numbers.

### Overview of the Method of Equity Ownership Optimization According to the Principles of the Present Invention

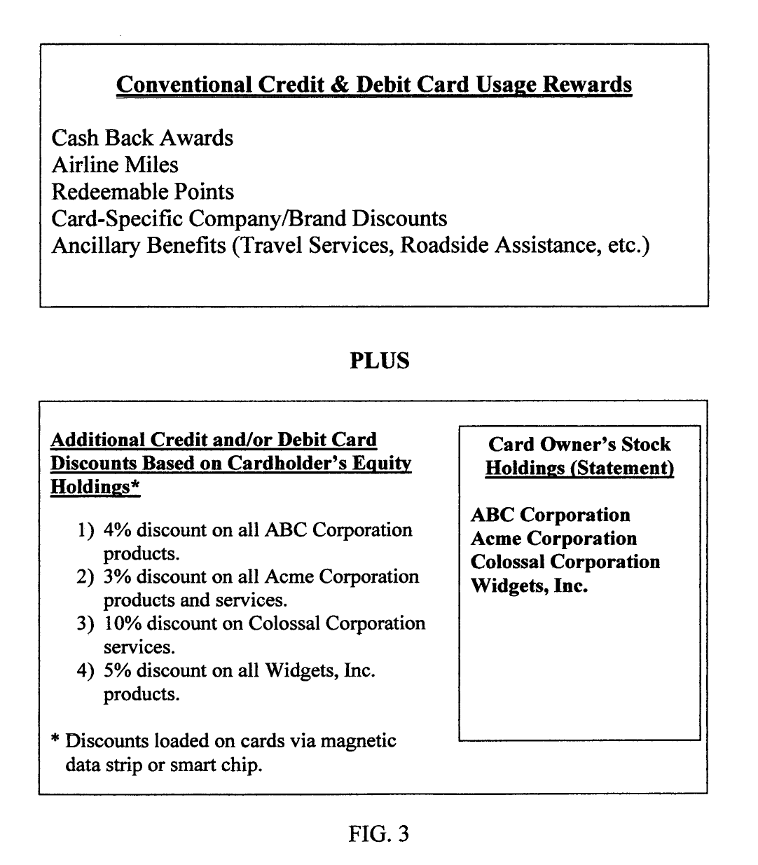

Referring to FIG. 3, there is presented an important concept that recognizes both existing credit card, debit card and other purchase/payment vehicle rebates, rewards, discounts, coupons and other offers/incentives and new rebates, rewards, discounts, coupons and other offers/incentives based on a credit card, debit card or other purchasing vehicle holder's equity holdings, both direct and indirect (mutual finds, etc.) that allow a system user to optimize his/her equity holdings. This optimization occurs in several different ways. First, the equity holder receives various new rebates, rewards, discounts, coupons and other offers/incentives based on the underlying equity holdings. Second, by focusing on, and purchasing, the various products and/or services offered by the companies held in the user's equity portfolio, the user is able to direct more purchases to these companies, further helping the companies held by the user. Finally, in addition to the various additional rebates, rewards, discounts, coupons and other offers/incentives the user receives as a result of his/her equity holdings, the user may be able to purchase additional rebates, rewards, discounts, coupons and other offers/incentives from those companies owned in the user's equity portfolio. As will be described in great detail hereinafter, the optimization of the user's underlying equity holdings is carried out using the Internet-based Equity Ownership Optimization Network (EOON) of the present invention.

### Overview of the Internet-Based Equity Ownership Optimization Network of the Present Invention

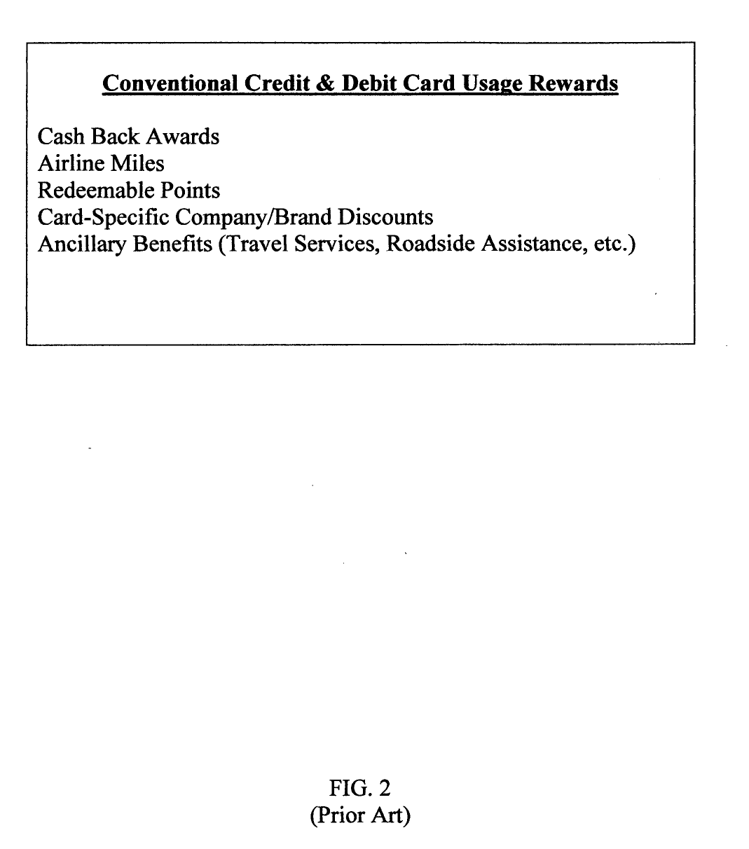

As shown in FIG. 3, the Internet-based EOON of the present invention represents a significant improvement on the “Conventional Credit and Debit Card Usage Rewards” as shown in FIG. 2. In this figure, the EOON is shown not only awarding the conventional rewards and ancillary items offered through existing credit and debit cards, but also offering additional, individual rebates, rewards, discounts, coupons and other offers/incentives based on the system user's equity holdings (both direct and indirect) and other rebates, rewards, discounts, coupons and other offers/incentives made available for purchase via the system of the present invention.

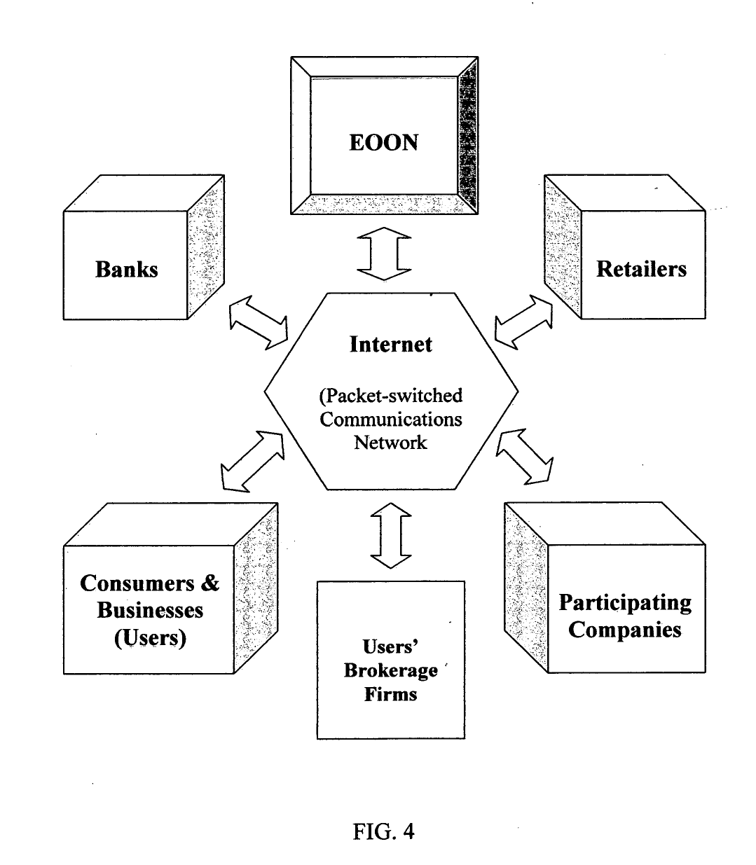

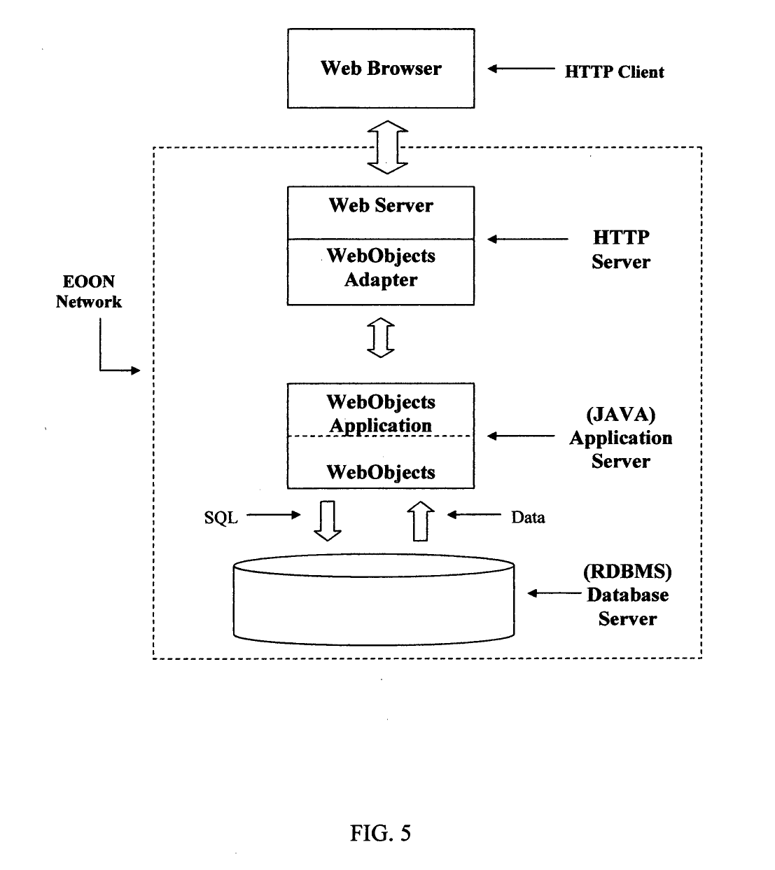

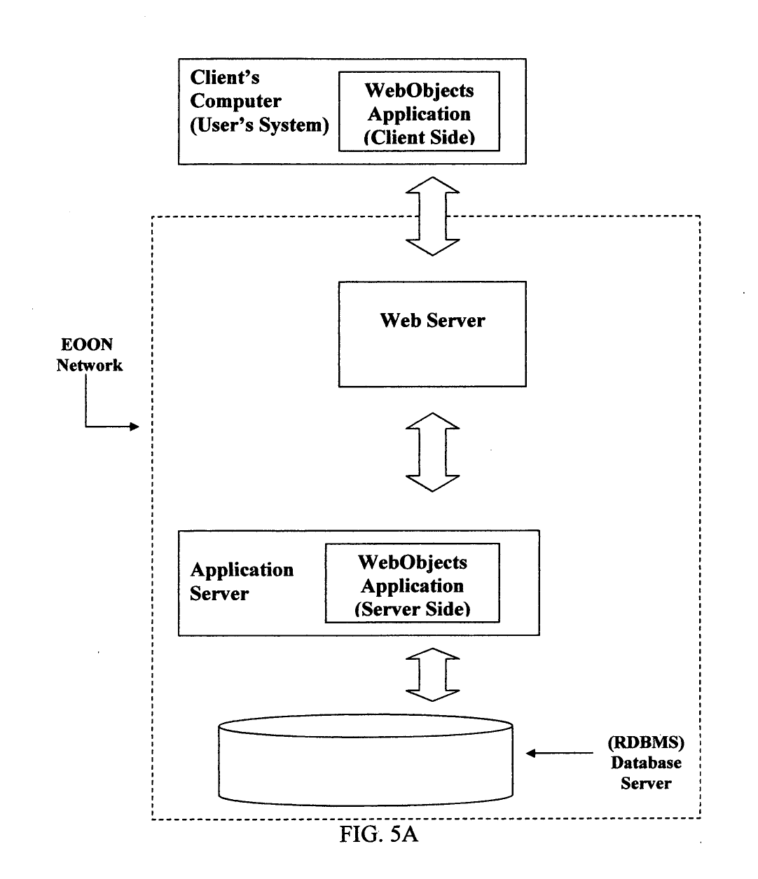

As shown in FIG. 4, the Internet-based EOON of the present invention is shown comprising various enterprise level information systems and supporting global financial information services for each entity registered as a participating member of the network (e.g. banks, participating companies, retailers, users' brokerage firms and users themselves). Communicating via the Internet, each participant is able to communicate with the other participants to facilitate the optimization of a user's credit card, debit card and/or other purchasing vehicle based on the system user's underlying equity holdings.

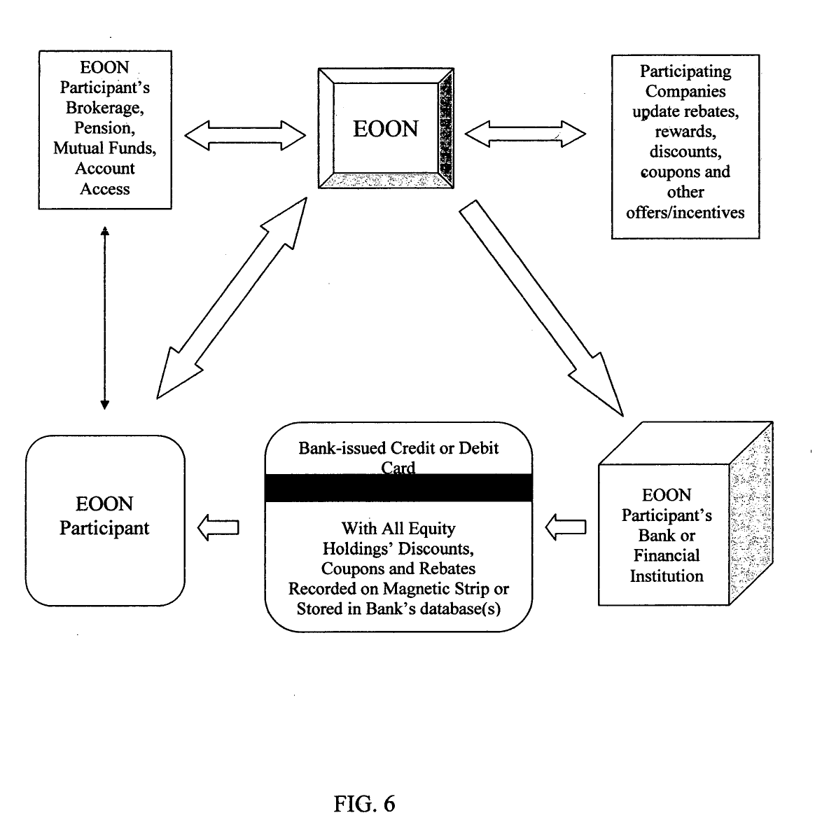

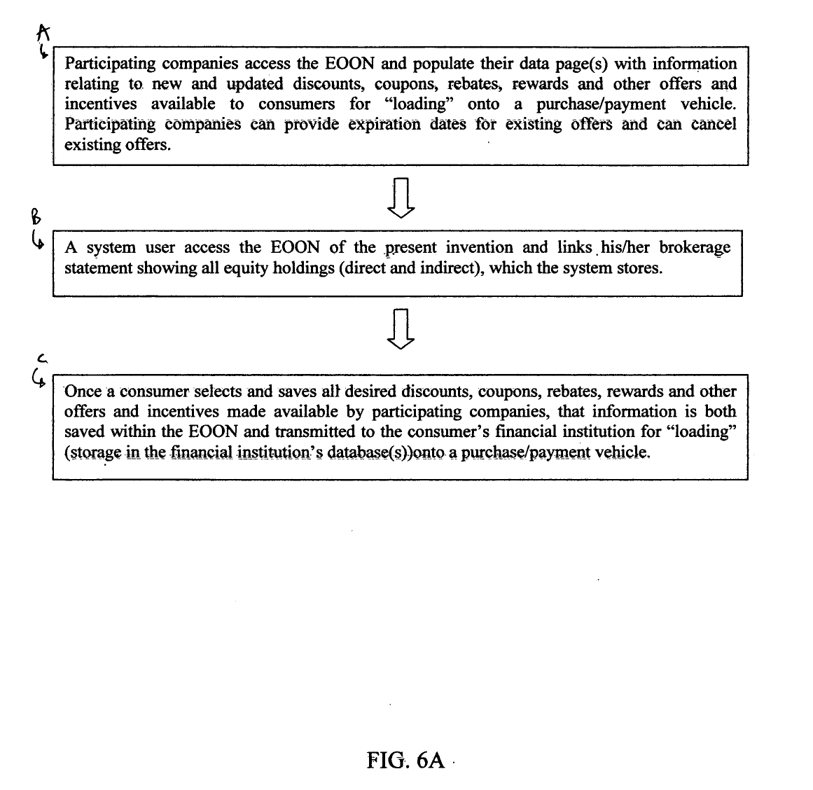

As shown in FIG. 6, “Equity Ownership Optimization Network (EOON) Process of Loading Equity-based and Free Rewards on a Purchasing Vehicle of the Present Invention”, a system user communicates with the EOON via the Internet (though other means of communication are possible) to link his/her stock brokerage account to the EOON; this may be done directly by the system user or via the system user's stock brokerage firm. Participating companies also link to the EOON via the Internet to supply information to the EOON's databases on the companies' offered rebates, rewards, discounts, coupons and other offers/incentives that can be “loaded” onto both an equity owner's (via ownership, purchase or for free) or non-equity owner's (via purchase or for free) credit card, debit card or other purchase/payment vehicle.

An EOON user can then access the EOON directly via the Internet to select for free or for purchase, rebates, rewards, discounts, coupons and other offers/incentives offered by participating companies in which the user already has an equity interest or, to “load” for free or to purchase offered rebates, rewards, discounts, coupons and other offers/incentives from companies in which the system user has no equity interest.

Once an EOON system user has confirmed all of the free and/or purchased rebates, rewards, discounts, coupons and other offers/incentives for inclusion on the user's credit card, debit card or other purchase/payment vehicle, the EOON first stores, then communicates, that information directly to the bank or financial institution of the system that issued the system user's card, debit card or other purchase/payment vehicle for storage in that bank's or institution's database(s).

The EOON then notifies the system user, via email, Web site or other means, any time participating companies' offers change, either allowing additional rebates, rewards, discounts, coupons and other offers/incentives to be “loaded” onto a user's credit/debit card or purchase/payment vehicle or necessitating the removal of various rebates, rewards, discounts, coupons and other offers/incentives in the event either the system user no longer owns a particular equity position or the discounts or other incentives have expired.

EOON Display of Available Rebates, Rewards, Discounts, Coupons and Other Offers and Incentives based on a System User's Equity Holdings (Direct and Indirect)

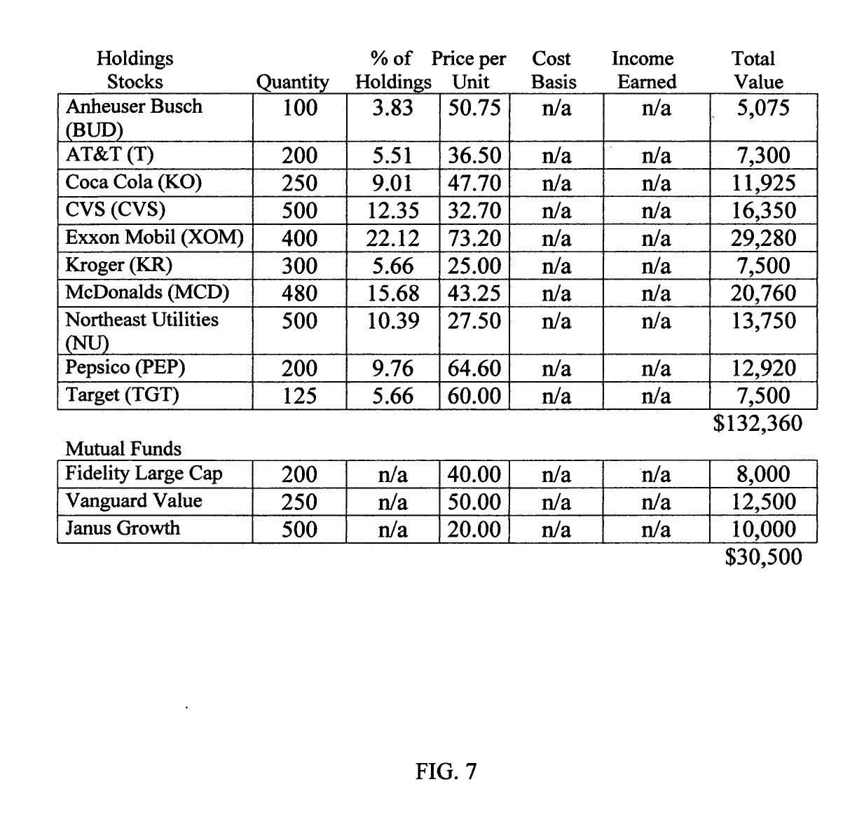

FIG. 7 shows a system user's sample equity statement from his/her brokerage firm. This statement, which the system user links to the EOON via the Internet, shows the names and stock symbols of the individual stocks owned by the system user along with the number of shares/units owned of each company, the percentage each holding represents in the user's overall stock portfolio, the market price per share/unit, the system user's original cost basis, any income earned (dividends, etc.), and the total value of each individual holding along with the cumulative value of the entire equity portfolio. Additionally, FIG. 7 shows the user's mutual fund holdings along with the aforementioned information where applicable.

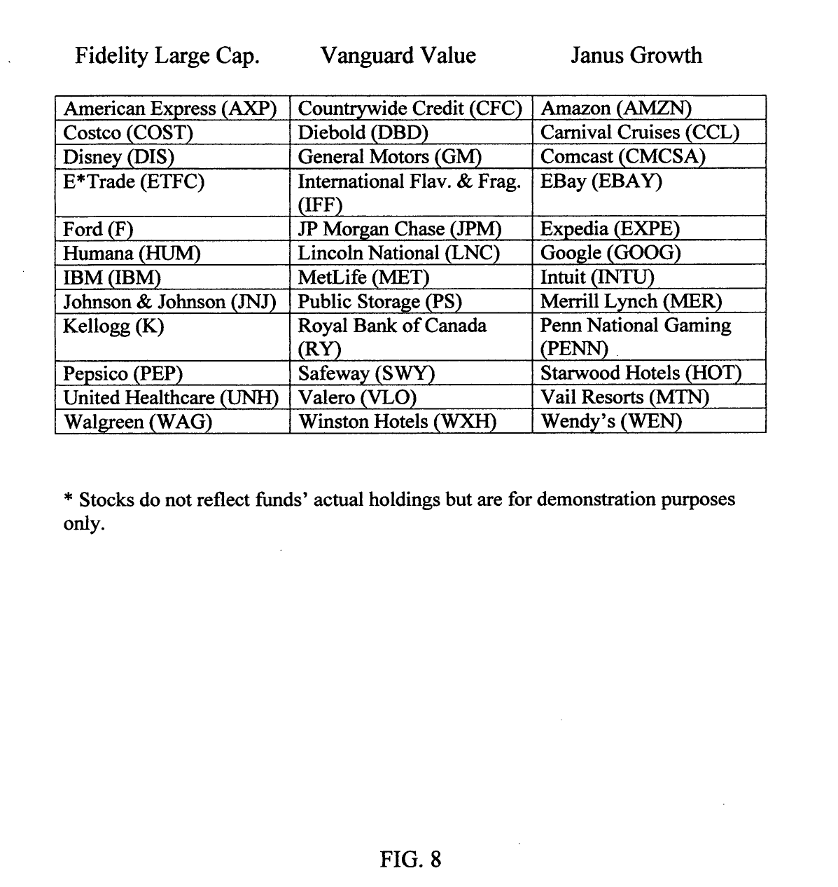

FIG. 8 shows the “EOON Customer's Mutual Fund Holding Positions”, which allows a system user to also receive offered rebates, rewards, discounts, coupons and other offers and incentives available to indirect equity holders by virtue of owning an interest in those companies through a mutual fund. This allows a much broader range of rebates, rewards, discounts, coupons and other offers/incentives to be made available to a system user and, for individuals who only invest through mutual funds, it allows them to receive free and purchasable rebates, rewards, discounts, coupons and other offers/incentives that they otherwise would not receive.

The information about mutual funds' equity holdings is available through many public sources although often with a significant time lag from when the equity positions were originally established to when they are published for public consumption. An ancillary benefit of the EOON is that it will encourage mutual fund managers to report their holdings more rapidly in order to make the offered rebates, rewards, discounts, coupons and other offers/incentives more readily available to their mutual find investors.

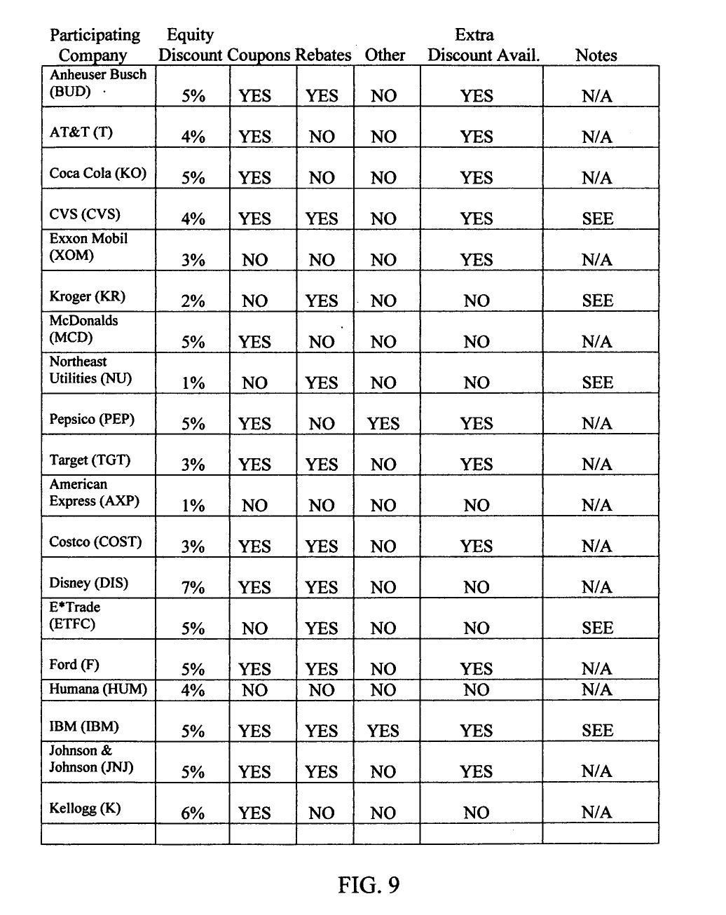

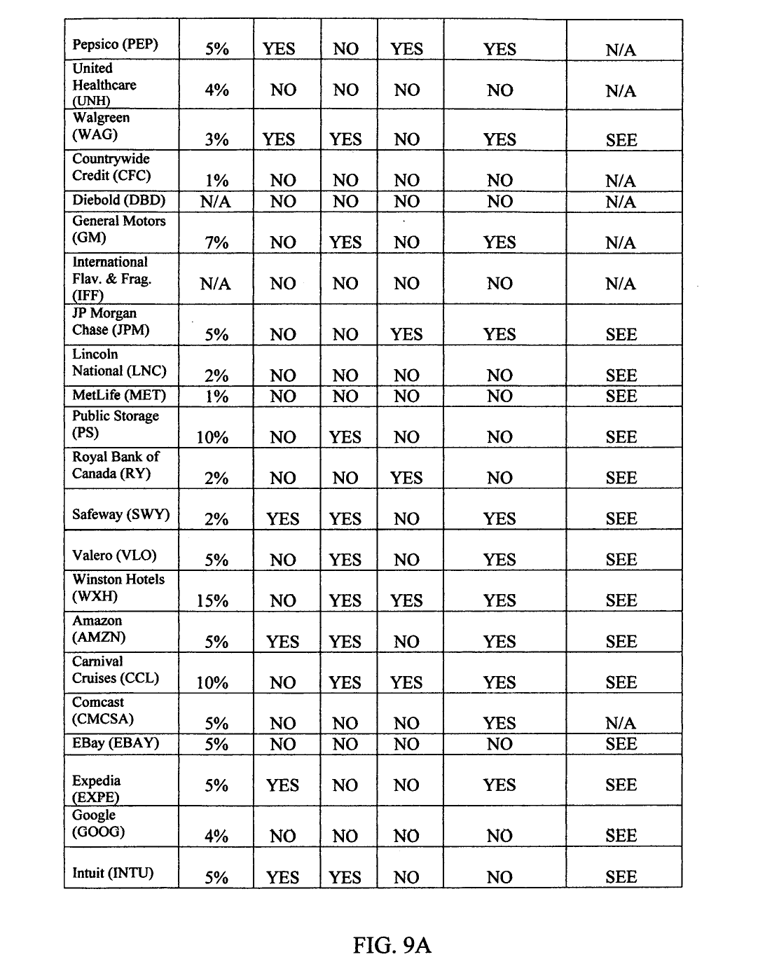

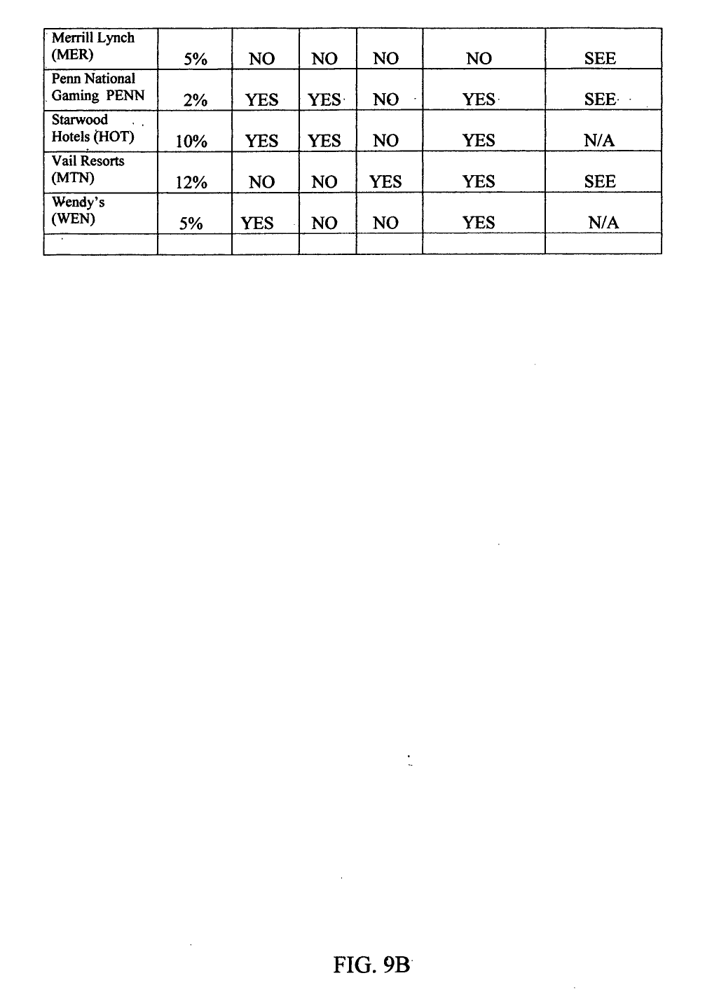

As shown in FIGS. 9, 9A & 9B, the “EOON Display of Available Rebates, Rewards, Discounts, Coupons and Other Offers and Incentives” shows all participating companies' offers, including a discount (if any) for equity holdings based on the system user's equity statement (FIG. 7) and on the indirect equity interests a system user may hold through a mutual find (or other indirect) investment (FIG. 8).

The EOON lists all of the participating companies' available offered rebates, rewards, discounts, coupons and other offers/incentives. The system user can gain access to more information about any and all of the information displayed in FIG. 9 simply by clicking on each company name or on any information displayed in a column or row.

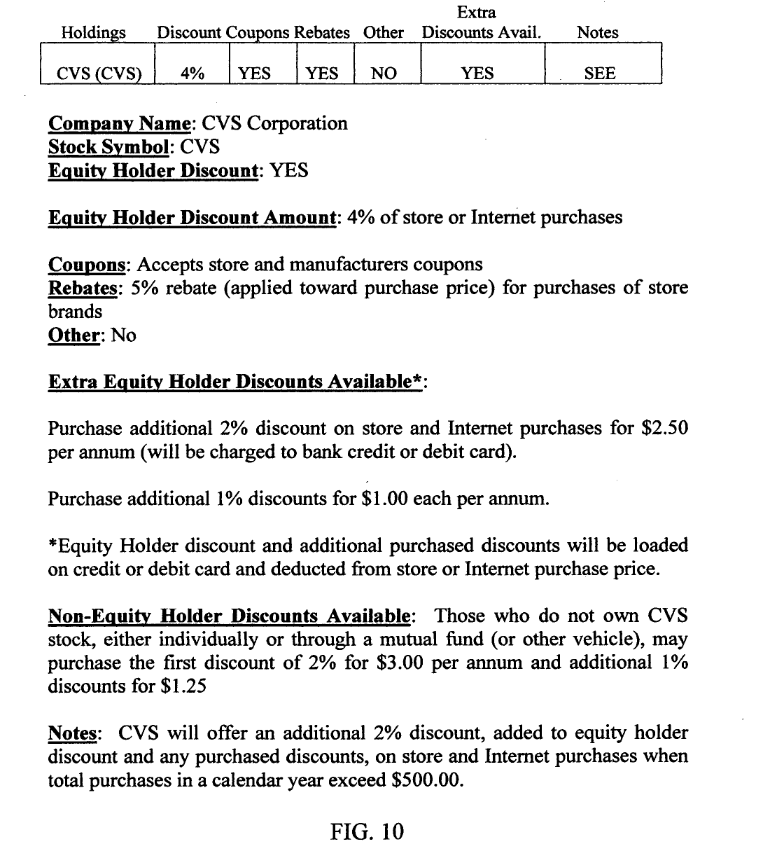

By clicking on a company's name or any cell in the row for a given company, the EOON then transports the system user to the “EOON Participating Company's Information Data Collection Sample”, as shown in FIG. 10. This page is company-specific, and shows the whole cell row from the previous page in FIG. 9. Beneath the cell row are the company name, company stock symbol, and information as to whether a company offers an equity holder discount. If the answer is “YES”, the details related to any and all equity holder offered rebates, rewards, discounts, coupons and other offers/incentives is displayed along with any additional offers of rebates, rewards, discounts, coupons and other offers/incentives that may be available for free or for purchase by an equity holder. Displayed below that is information about rebates, rewards, discounts, coupons and other offers/incentives the company offers to non-equity holders. Finally there is a “Notes” section that explains all rebates, rewards, discounts, coupons and other offers/incentives offered.

### EOON Display of Companies Offering Free and Purchasable Rewards, Discounts and Rebates for Non-Equity Holders

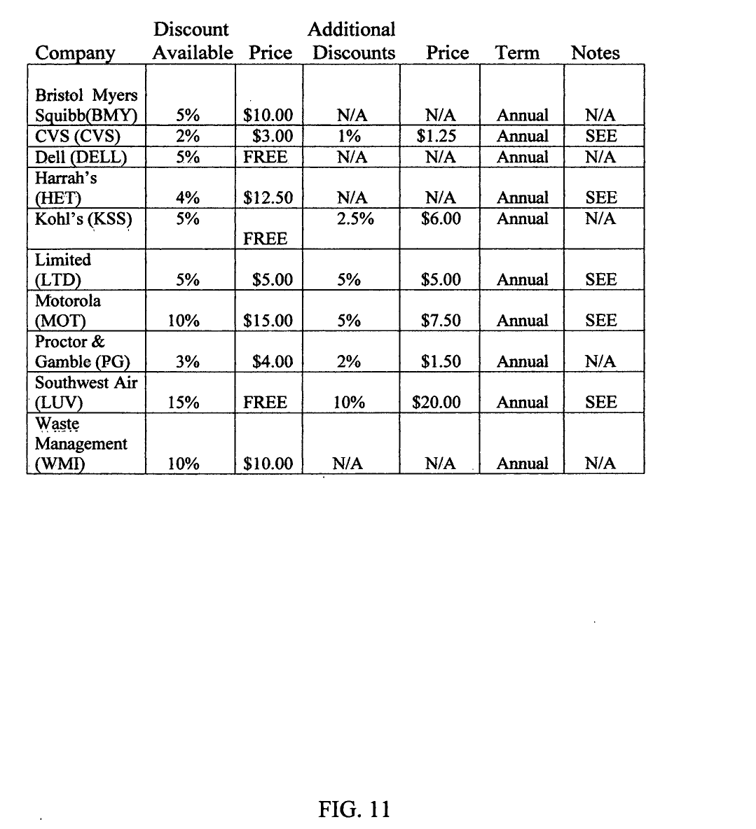

Shown in FIG. 11 is the “EOON Menu of Companies Offering Free and Purchasable Rebates, Rewards, Discounts, Coupons and Other Offers and Incentives for Non-Equity Holders”, which shows all companies participating in the EOON that offer any type of rebates, rewards, discounts, coupons and other offers/incentives available either for free or for purchase by non-equity holders. EOON users can access this page and review all available rebates, rewards, discounts, coupons and other offers/incentives that participating companies make available to everyone. Along with the company name, this page shows the various rebates, rewards, discounts, coupons and other offers/incentives available for “loading” on a credit card, debit card or other purchase/payment vehicle, along with prices (if any) for each offered rebate, reward, discount, coupon and other offer(s) and incentive(s).

### EOON Participating Companies' Products and Services Cross-Reference Guides

There are two different ways for users of the EOON System to check for products and services offered by various companies. This is an important service because it allows an equity holder (or non-equity holder) of a particular company to discover other products and services offered by that company. The user can then buy additional products and services from that company utilizing any rebates, rewards, discounts, coupons and other offers/incentives made available by that company. Furthermore, the system user, by using the products and services of companies in which an equity interest is held, can increase the business done by those companies, thereby helping the system user's equity holdings become more profitable.

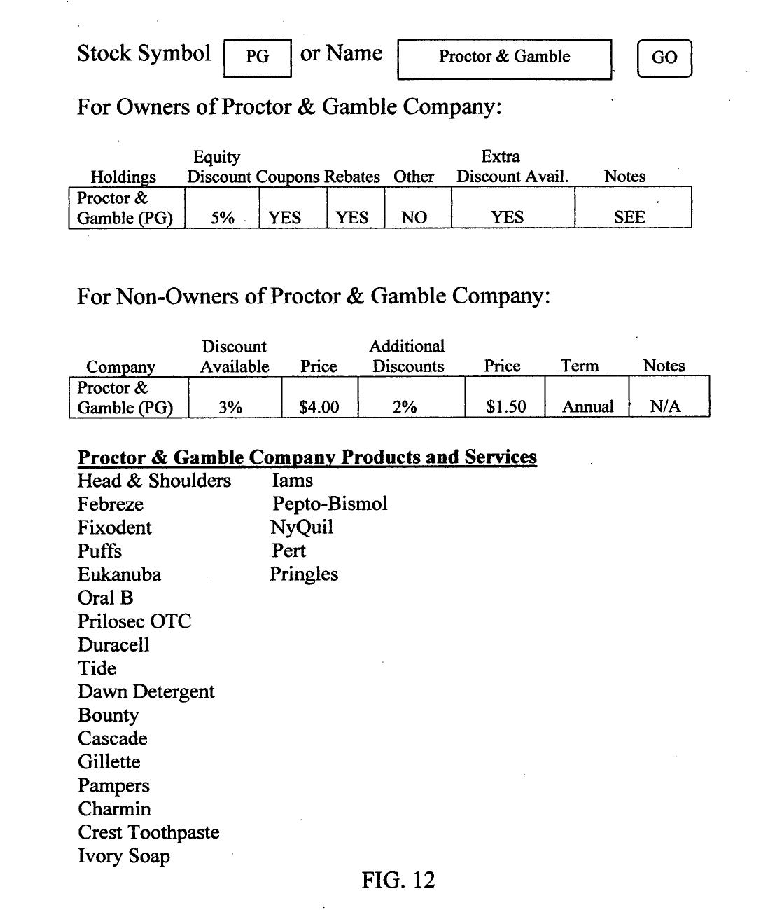

Shown in FIG. 12 is the “EOON” Participating Company Products List”, which allows a system user to type in either a company name or the company stock symbol and click on the “GO” button to display both the offers of rebates, rewards, discounts; coupons and other offers/incentives available to equity holders (owners) and to non-equity holders. Furthermore, this page also displays all other available products and/or services a particular company offers, enabling a system user to maximize the user of a particular company's products and, at the same time, receive additional rebates, rewards, discounts, coupons and other offers/incentives for that company's products/services.

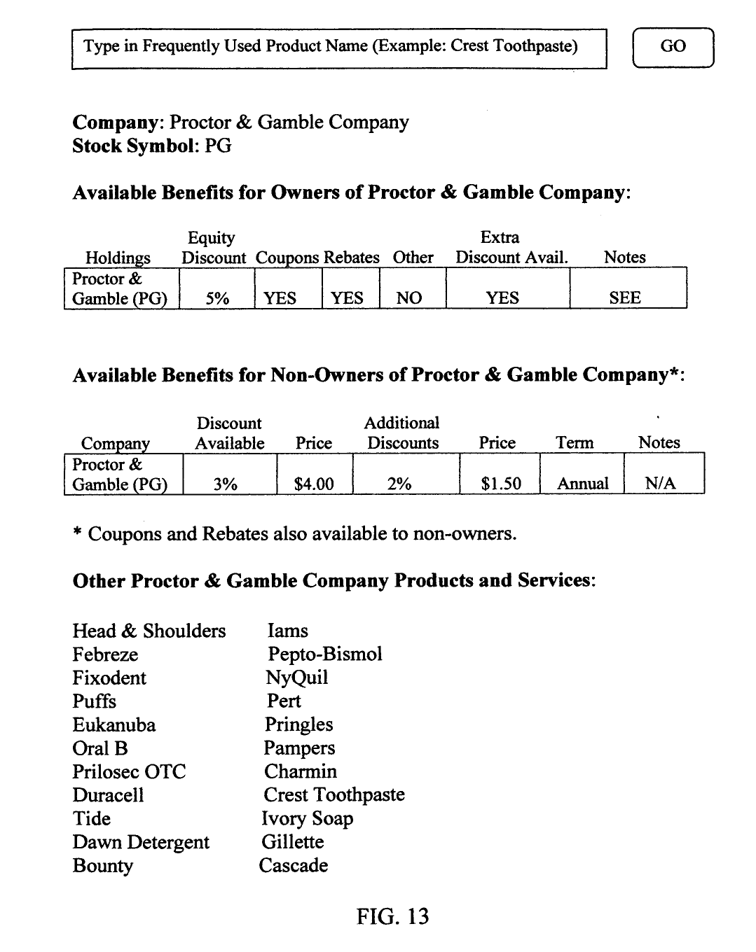

Similarly, FIG. 13 shows the “EOON User's Frequently Used Products Search Menu” that allows a system user to type in frequently used products by brand name to get information on the company that makes them. This allows a system user to discover the name of the company that makes the product, to see available rebates, rewards, discounts, coupons and other offers/incentives offered to both equity holders and non-equity holders, and to see other products and/or services offered by a particular company. Should a system user frequently use one or more of a participating company's products, he/she might consider investing in that company in order to receive the company's offered rebates, rewards, discounts, coupons and other offers/incentives available to equity holders.

### EOON Participating Company Data Collection

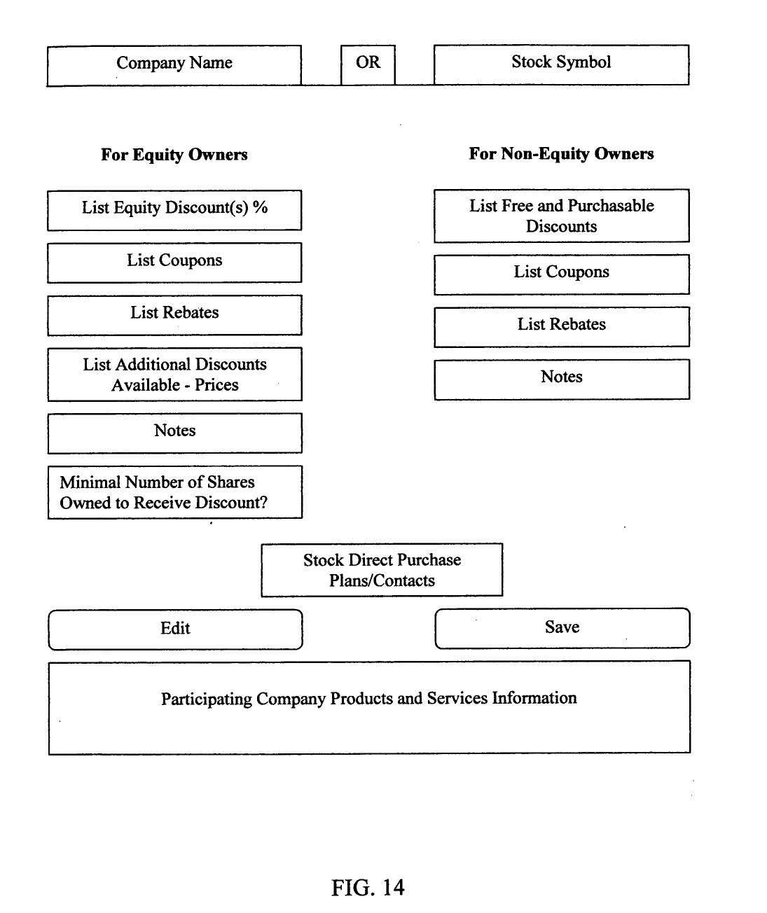

As shown in FIG. 14, the “EOON Participating Company Information Update Screen” allows participating companies to access the EOON directly via the Internet in order to update all of their company information. This includes information on all offered rebates, rewards, discounts, coupons and other offers/incentives available to both equity holders and non-equity holders. Once entered (updated) the company's offered rebates, rewards, discounts, coupons and other offers/incentives will be displayed in the screens shown in FIGS. 9, 9A, 9B, 10, 11, 12 and 13.

Furthermore, for equity holders, it allows a company to specify either a minimum holding period: for its stock and/or a minimum investment (for direct investments) to preclude a system user from holding either a minimal amount of stock or from buying and selling the stock rapidly to obtain a one-off discount.

The EOON system of the present invention can monitor both the amount of the investment and the holding period, and can escrow certain rebates, rewards, discounts, coupons and other offers/incentives in order to assure that a system user meets the participating company's ownership criteria for receiving said rebates, rewards, discounts, coupons and other offers/incentives.

There is also an area that allows a participating company to list information related to any direct stock purchase program(s) the company may offer, along with a box that allows a participating company to list all available products and services either included in the rebates, rewards, discounts, coupons and other offers/incentives it offers and/or all of the companies available products and/or services.

Finally, the company can edit and save this information every time it accesses it page.

### EOON System Credit Card, Debit Card and Other Purchasing Vehicle User Optimization Menu

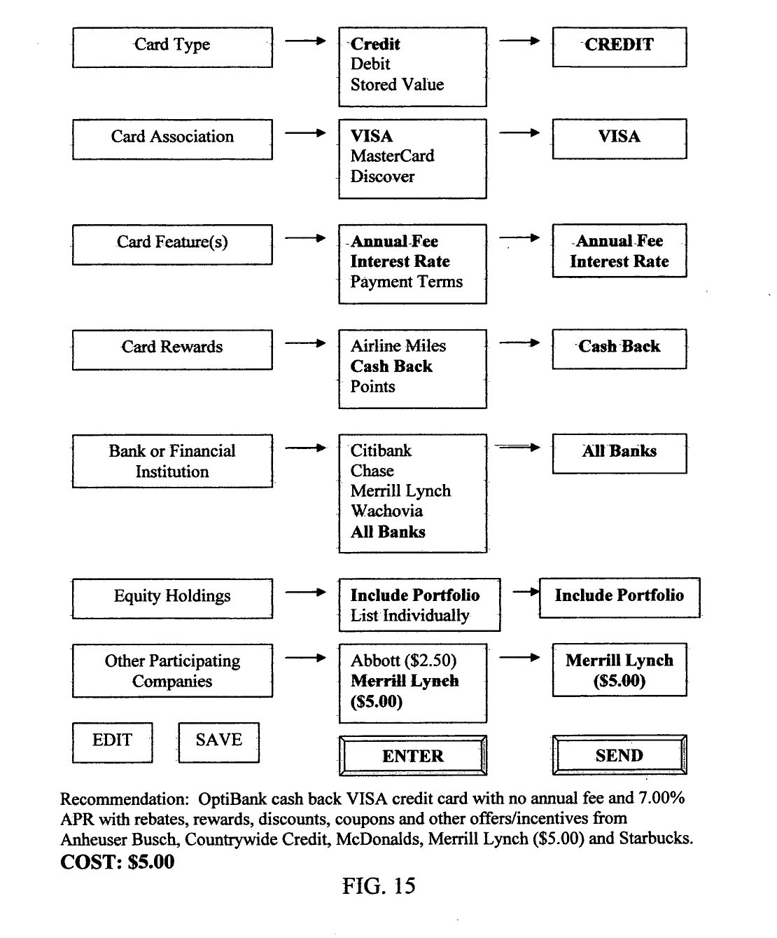

Another very important part of the EOON is its “EOON Credit & Debit Card User Optimization Menu”, as shown in FIG. 15, which allows a system user to design his/her own credit or debit card (or any other available purchase/payment vehicle) by making selections about the type(s) of card the system user desires along with the various attributes desired in the card(s) by a system user; it essentially allows a system user to design his/her own credit or debit card.

The system user accesses this graphical user interface (GUI) screen that allows selection of type of card (credit, debit, stored value, etc.), card association (VISA, MasterCard, American Express, Discover, others), important card features (annual fee, interest rate on balances, etc.), default card rewards (airline miles, cash back, points, etc.), the user's preferred bank or financial institution (if any), the user's equity portfolio, which allows a user to include all offered rebates, rewards, discounts, coupons and other offers/incentives available to the user as an equity holder and, finally, “Other Participating Companies”, which allows a user to select various rebates, rewards, discounts, coupons and other offers/incentives from companies in which he/she does not hold an equity interest.

In the “Other Participating Companies” selection process/window, the system user can scroll down the list to see various companies' offers along with the prices (if any) of those offers. In the event the system user wants more information about a particular company's offerings, he/she can click on the offering and the system will open a separate screen showing the user a copy of the company's “EOON Participating Company's Data Collection Summary”, which allows a system user to see all of the company's offerings for non-equity holders along with their respective prices.

Once a system user has made all of choices, which are displayed in a separate window for each choice, for a particular card product, he/she hits enter at the bottom of the page and the system of the present invention will recommend that card option(s) that most closely matches the user's inputs. In the case of purchasable company rebates, rewards, discounts, coupons and other offers/incentives, the system will show a price for each selected company's rebates, rewards, discounts, coupons and other offers/incentives as well as a total cost (if any) for the system user's desired card product.

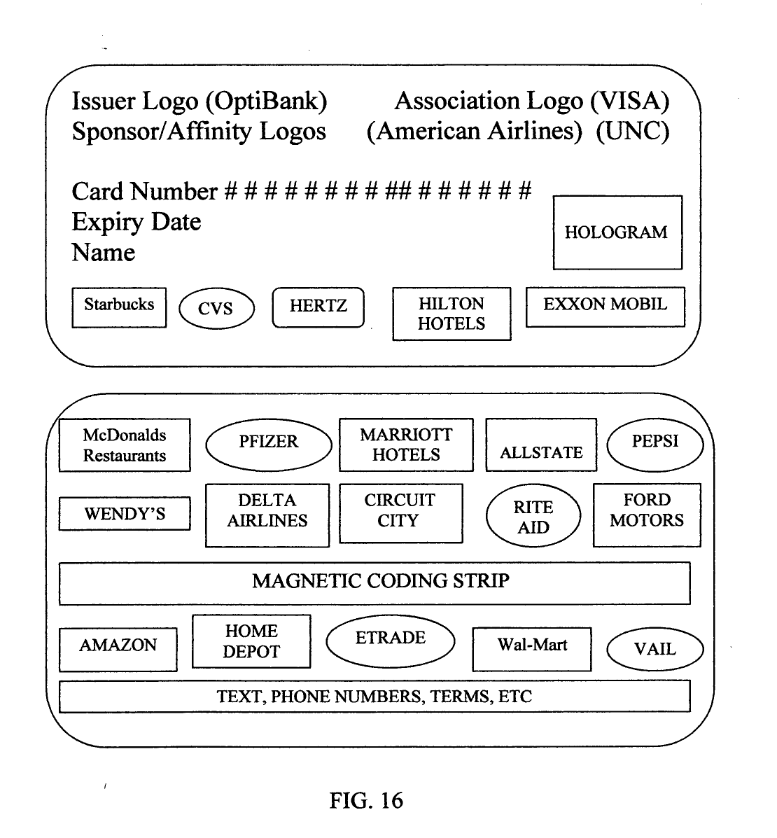

Once a system user has made all of his/her preferred choices for a card or other purchasing vehicle, the system will then display, as seen in FIG. 16, templates of both the front and back of the user's preferred card or purchase/payment vehicle product, replete with Issuer, Association, Sponsor and/or Affinity Group, Card Number, Expiry Date, User's Name, all applicable company logos (space permitting), magnetic coding strip and other information. The user can manually move around the included company logos to his/her preferred location on the card with the proviso that critical card information not be obscured by any logo.

Once the system user is satisfied with a card or purchasing vehicle choice, the system user can then transmit the desired card's specifications to the chosen financial institution, via the screen shown in FIG. 15, where all of the equity holder-related, and purchased, rebates, rewards, discounts, coupons and other offers/incentives will be “loaded” on the system user's new credit card, debit card or other purchasing vehicle by transmitting the default and selected equity holder-related, and purchased, rebates, rewards, discounts, coupons and other offers/incentives for storage in the chosen bank's/financial institution's database(s).

### Operational EOON System of the Present Invention

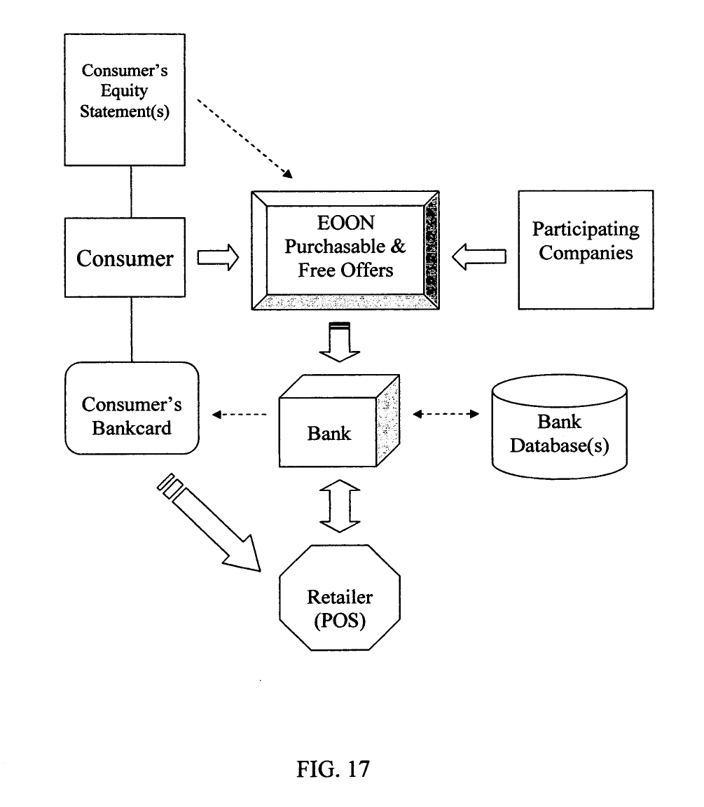

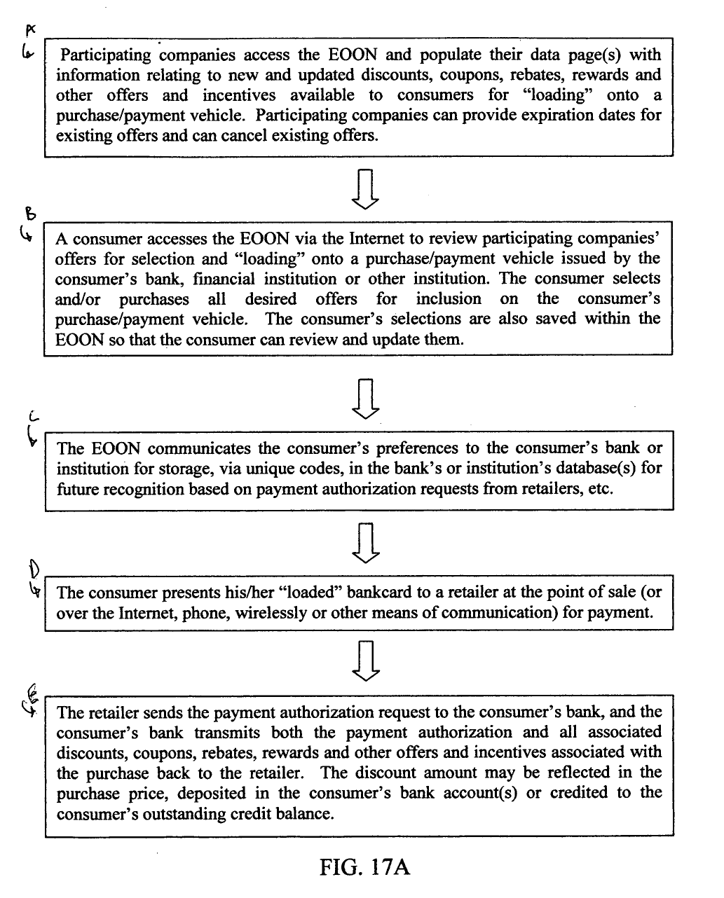

FIG. 17 contains a high-level flow chart of the EOON system of the present invention, in which a consumer accesses the EOON system of the present invention and may, or may not, link his/her equity statement to the system.

Once the consumer accesses the EOON, the consumer can then navigate to participating companies' discount, coupon, rebate and other offers and incentives information, which the company has provided through Internet link to the EOON. Once a consumer has selected the various discounts, coupons, rebates and other offers and incentives for inclusion in a purchase/payment vehicle, the consumer then saves that information within the EOON, which then transmits the consumer's choices to the appropriate bank or financial institution for storage in its database(s) as the consumer's specific information.

When a consumer then presents his/her “loaded” purchase/payment vehicle to a retailer at the point of sale (this may be done physically or via the Internet, phone, wirelessly or by other means of communication), the retailer swipes the vehicle, which initiates the authorization process at the consumer's bank or financial institution.

The bank or financial institution, having received the retailer's request for payment authorization, accesses the consumer's choices stored in its database(s) and includes all pertinent discount, coupon, rebate and other offer and incentive information related to the consumer's purchase, when it responds to the retailer's authorization request.

As noted previously, the total discount amount may be applied directly to the purchase price, deposited in the consumer's bank account or, in the case of credit vehicles, applied directly to the consumer's outstanding credit balance.

What is claimed:

1. An Internet-based method of and system, wherein the rights of equity holders (direct and indirect), as owners of participating companies, to receive all available rebates, rewards, discounts, coupons and other offers/incentives offered by those companies are recognized and communicated, thereby encouraging shareholder loyalty and thus enabling the maximization of both the equity owners' interests as both company owners and consumers, and the companies' interests of maximizing sales and rewarding their owners.

2. The Internet-based method and system of claim 1, wherein additional free and purchasable rebates, rewards, discounts, coupons and other offers/incentives that an equity holder receives from the various companies in which he/she has an equity interest are communicated to the equity holder/system user directly by the participating companies.

3. The Internet-based method and system of claim 1, wherein additional free rebates, rewards, discounts, coupons and other offers/incentives are made available by participating companies, either for free or for purchase, to system users, who are equity holders and/or non-equity holders.

4. An Internet-based method and system, wherein participating companies' rebates, rewards, discounts, coupons and other offers/incentives, are input to the system of the present invention via Internet, electronic or other means, for display and selection by users, with participating companies having the ability to initiate, change or cancel offers through the system.

5. The Internet-based method and system of claim 4, wherein consumer can access the participating companies offers via Internet, electronic or other means, and select various offers for inclusion and “loading” onto a purchase/payment vehicle, with such selections both stored/saved within the system of the present invention and communicated to the consumer's financial institution of choice.

6. The Internet-based method and system of claim 4, wherein the consumer's saved selections that have been communicated to the consumer's purchase/payment vehicle issuing institution are stored within the issuing institution's database(s) for future recognition and employment in the consumer's transactions with said purchase/payment vehicle.

7. The Internet-based method and system of claim 1, wherein an equity holder (direct or indirect) is able to link a stock brokerage statement or other lists of owned equities for the purpose of receiving any and all available rebates, rewards, discounts, coupons and other offers/incentives related to the listed companies owned.

8. The Internet-based method and system of claim 4, wherein participating companies can upload, for display on the system of the invention, all available rebates, rewards, discounts, coupons and other offers/incentives for both equity holders (direct and indirect) and non-equity holders with various prices and terms, where applicable; companies can edit and save such information.

9. The Internet-based method and system of claim 4, wherein consumers can enter either the name of a company or a company's stock symbol and ascertain both available rebates, rewards, discounts, coupons and other offers/incentives offered by the company or view all products and/or services made/offered by the company.

10. The Internet-based method and system of claim 4, wherein consumers can enter the name(s) of frequently used products and ascertain the name(s) of the company that produces them along with all available rebates, rewards, discounts, coupons and other offers/incentives offered by the company.

11. An Internet-based method and system, wherein consumers and other users are able to select various choices from menus, based upon information supplied by banks and financial institutions, in order to create a credit card, debit card or other purchasing vehicle with various attributes that optimize the consumer's/user's preferences based on both the banks' default product offerings and on the consumer's/user's equity holdings-related, purchasable, and free, rebates, rewards, discounts, coupons and other offers/incentives.

12. The Internet-based method and system of claim 11, wherein users are able to see both the front and back of a proposed card or purchasing vehicle product based on their menu selections, with such card or product containing standard credit or debit card information (name, account number, magnetic strip, etc.) along with logos of all equity and non-equity owned companies from which the user receives rebates, rewards, discounts, coupons and other offers/incentives.

13. The Internet-based method and system of claim 4, wherein participating companies are identified by separate, unique codes that are loaded onto a credit card, debit card or other purchasing vehicle, or stored in a database, by a bank or financial institution, with such codes giving an equity holder entitled to rebates, rewards, discounts, coupons and other offers/incentives, or non-equity holder that has “loaded” free, or purchased, available rebates, rewards, discounts, coupons and other offers/incentives, all of the available rebates, rewards, discounts, coupons and other offers/incentives offered by participating companies for recognition at the point of sale.
